(19) United States
(12) Patent Application Publication
(10) Pub. No.: US 2013/0160469 A1
(43) Pub. Date: Jun. 27, 2013

(54) USE OF E-1,1,1,4,4,5,5,5-OCTAFLUORO-2-PENTENE AND OPTIONALLY 1,1,1,2,3-PENTAFLUOROPROPANE IN CHILLERS

(71) Applicant: E I DU PONT DE NEMOURS AND COMPANY, Wilmington, DE (US)

(72) Inventor: KONSTANTINOS KONTOMARIS, Wilmington, DE (US)

(73) Assignee: E I DU PONT DE NEMOURS AND COMPANY, Wilmington, DE (US)

(21) Appl. No.: 13/722,230

(22) Filed: Dec. 20, 2012

Related U.S. Application Data
(60) Provisional application No. 61/578,366, filed on Dec. 21, 2011.

(51) Int. Cl. C09K 5/00

(52) U.S. Cl. CPC C09K 5/00
USPC 62/56; 252/68; 62/467

(57) ABSTRACT

This invention relates to method for producing cooling in a chiller having an evaporator wherein a refrigerant composition is evaporated to cool a heat transfer medium and the cooled heat transfer medium is transported out of the evaporator to a body to be cooled, wherein said chiller is a centrifugal chiller. The method comprises evaporating a composition comprising E-HFO-1438mzz and optionally HFC-245eb as a refrigerant composition in the evaporator. This invention also relates to a composition comprising: (1) a refrigerant component consisting essentially of HFC-245eb and E-HFO-1438mzz; and (2) a lubricant suitable for use in a chiller; wherein the E-HFO-1438mzz in the refrigerant is at least 1 weight percent. This invention also relates to a centrifugal chiller apparatus containing a refrigerant composition, characterized by said refrigerant comprising E-HFO-1438mzz and optionally HFC-245eb.

### CROSS REFERENCE(S) TO RELATED APPLICATION(S)

This application claims the priority benefit of U.S. Provisional Patent Application No. 61/578,366, filed Dec. 21, 2011.

### FIELD OF THE INVENTION

This invention relates to methods and systems for producing cooling in numerous applications, and in particular, in chillers.

### BACKGROUND OF THE INVENTION

The compositions of the present invention are part of a continued search for the next generation of low global warming potential materials. Such materials must have low environmental impact, as measured by ultra-low global warming potential and zero ozone depletion potential. New materials are needed in the area.

### SUMMARY OF THE INVENTION

This invention relates to compositions comprising E-1,1,1,4,4,5,5,5-octafluoro-2-pentene (i.e., E-HFO-1438mzz) and optionally 1,1,1,2,3-pentafluoropropane (i.e., HFC-245eb), as well as methods and systems using E-HFO-1438mzz and optionally HFC-245eb in chillers.

Embodiments of the present invention involve the compound E-HFO-1438mzz, either alone or in combination with one or more other compounds as described in detail herein below.

In accordance with the present invention a method for producing cooling in a chiller having an evaporator wherein a refrigerant composition is evaporated to cool a heat transfer medium and the cooled heat transfer medium is transported out of the evaporator to a body to be cooled. The method comprises evaporating a refrigerant composition comprising E-HFO-1438mzz and optionally HFC-245eb in the evaporator; wherein said chiller is a centrifugal chiller.

In accordance with this invention, a composition is provided. The composition comprises: (1) a refrigerant component consisting essentially of HFC-245eb and E-HFO-1438mzz; and (2) a lubricant suitable for use in a chiller; wherein the E-HFO-1438mzz in the refrigerant component is at least 1 weight percent.

In accordance with this invention, a centrifugal chiller apparatus containing a refrigerant composition is provided. The apparatus is characterized by said refrigerant composition comprising E-HFO-1438mzz and optionally HFC-245eb.

In accordance with this invention, method for replacing HCFC-123 in a centrifugal chiller designed for using HCFC-123 as refrigerant composition is provided. The method comprises charging said centrifugal chiller with a composition comprising a refrigerant component consisting essentially of E-HFO-1438mzz and optionally HFC-245eb.

### BRIEF DESCRIPTION OF THE DRAWINGS

FIG. 1 is a schematic diagram of one embodiment of a centrifugal chiller having a flooded evaporator that may use a refrigerant composition comprising E-HFO-1438mzz and optionally HFC-245eb.

FIG. 2 is a schematic diagram of one embodiment of a centrifugal chiller having a direct expansion evaporator that may use a refrigerant composition comprising E-HFO-1438mzz and optionally HFC-245eb.

### DETAILED DESCRIPTION OF PREFERRED EMBODIMENTS

Before addressing details of embodiments described below, some terms are defined or clarified.

Global warming potential (GWP) is an index for estimating relative global warming contribution due to atmospheric emission of a kilogram of a particular greenhouse gas compared to emission of a kilogram of carbon dioxide. GWP can be calculated for different time horizons showing the effect of atmospheric lifetime for a given gas. The GWP for the 100 year time horizon is commonly the value referenced.

Ozone depletion potential (ODP) is defined in “The Scientific Assessment of Ozone Depletion, 2002, A report of the World Meteorological Association's Global Ozone Research and Monitoring Project,” section 1.4.4, pages 1.28 to 1.31 (see first paragraph of this section). ODP represents the extent of ozone depletion in the stratosphere expected from a compound on a mass-for-mass basis relative to fluorotrichloromethane (CFC-11).

As used herein, a heat transfer medium (or liquid cooling medium) comprises a composition used to carry heat from a body to be cooled to the chiller evaporator or from the chiller condenser to a cooling tower or other configuration where heat can be rejected to the ambient.

As used herein, a refrigerant composition is a composition which may be a single compound or comprise a mixture of compounds that functions to transfer heat in a cycle wherein the composition undergoes a phase change from a liquid to a gas and back to a liquid in a repeating cycle.

Refrigeration capacity (sometimes referred to as cooling capacity) is a term to define the change in enthalpy of a refrigerant composition in an evaporator per unit mass of refrigerant composition circulated. Volumetric cooling capacity refers to the amount of heat removed by the refrigerant composition in the evaporator per unit volume of refrigerant composition vapor exiting the evaporator. The refrigeration capacity is a measure of the ability of a refrigerant composition or heat transfer composition to produce cooling. Cooling rate refers to the heat removed by the refrigerant in the evaporator per unit time.

Coefficient of performance (COP) is the amount of heat removed in the evaporator divided by the energy required to operate the compressor. The higher the COP, the higher the energy efficiency. COP is directly related to the energy efficiency ratio (EER), that is, the efficiency rating for refrigeration or air conditioning equipment at a specific set of internal and external temperatures.

Subcooling is the reduction of the temperature of a liquid below that liquid's saturation point for a given pressure. The saturation point is the temperature at which a vapor composition is completely condensed to a liquid (also referred to as the bubble point). But subcooling continues to cool the liquid to a lower temperature liquid at the given pressure. Subcool amount is the amount of cooling below the saturation temperature (in degrees) or how far below its saturation temperature a liquid composition is cooled.

Superheat is a term that defines how far above its saturation temperature (the temperature at which, if the composition is cooled, the first drop of liquid is formed, also referred to as the “dew point”) a vapor composition is heated.

Temperature glide (sometimes referred to simply as “glide”) is the absolute value of the difference between the starting and ending temperatures of a phase-change process by a refrigerant composition within a component of a refrigerant system, exclusive of any subcooling or superheating. This term may be used to describe condensation or evaporation of a near azeotrope or non-azeotropic composition. Average glide refers to the average of the glide in the evaporator and the glide in the condenser of a specific chiller system operating under a given set of conditions.

An azeotropic composition is a mixture of two or more different components which, when in liquid form under a given pressure, will boil at a substantially constant temperature, which temperature may be higher or lower than the boiling temperatures of the individual components, and which will provide a vapor composition essentially identical to the overall liquid composition undergoing boiling. (see, e.g., M. F. Doherty and M. F. Malone, Conceptual Design of Distillation Systems, McGraw-Hill (New York), 2001, 185-186, 351-359).

Accordingly, the essential features of an azeotropic composition are that at a given pressure, the boiling point of the liquid composition is fixed and that the composition of the vapor above the boiling composition is essentially that of the overall boiling liquid composition (i.e., no fractionation of the components of the liquid composition takes place). It is also recognized in the art that both the boiling point and the weight percentages of each component of the azeotropic composition may change when the azeotropic composition is subjected to boiling at different pressures. Thus, an azeotropic composition may be defined in terms of the unique relationship that exists among the components or in terms of the compositional ranges of the components or in terms of exact weight percentages of each component of the composition characterized by a fixed boiling point at a specified pressure.

For the purpose of this invention, an azeotrope-like composition means a composition that behaves substantially like an azeotropic composition (i.e., has constant boiling characteristics or a tendency not to fractionate upon boiling or evaporation). Hence, during boiling or evaporation, the vapor and liquid compositions, if they change at all, change only to a minimal or negligible extent. This is to be contrasted with non-azeotrope-like compositions in which during boiling or evaporation, the vapor and liquid compositions change to a substantial degree.

As used herein, the terms “comprises,” “comprising,” “includes,” “including,” “has,” “having” or any other variation thereof, are intended to cover a non-exclusive inclusion. For example, a composition, process, method, article, or apparatus that comprises a list of elements is not necessarily limited to only those elements but may include other elements not expressly listed or inherent to such composition, process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

The transitional phrase “consisting of” excludes any element, step, or ingredient not specified. If in the claim such would close the claim to the inclusion of materials other than those recited except for impurities ordinarily associated therewith. When the phrase “consists of” appears in a clause of the body of a claim, rather than immediately following the preamble, it limits only the element set forth in that clause; other elements are not excluded from the claim as a whole.

The transitional phrase “consisting essentially of” is used to define a composition, method or apparatus that includes materials, steps, features, components, or elements, in addition to those literally disclosed provided that these additional included materials, steps, features, components, or elements do materially affect the basic and novel characteristic(s) of the claimed invention. The term ‘consisting essentially of’ occupies a middle ground between “comprising” and ‘consisting of’.

Where applicants have defined an invention or a portion thereof with an open-ended term such as “comprising,” it should be readily understood that (unless otherwise stated) the description should be interpreted to also describe such an invention using the terms “consisting essentially of” or “consisting of.”

Also, use of “a” or “an” are employed to describe elements and components described herein. This is done merely for convenience and to give a general sense of the scope of the invention. This description should be read to include one or at least one and the singular also includes the plural unless it is obvious that it is meant otherwise.

Unless otherwise defined, all technical and scientific terms used herein have the same meaning as commonly understood by one of ordinary skill in the art to which this invention belongs. Although methods and materials similar or equivalent to those described herein can be used in the practice or testing of embodiments of the present invention, suitable methods and materials are described below. All publications, patent applications, patents, and other references mentioned herein are incorporated by reference in their entirety, unless a particular passage is cited. In case of conflict, the present specification, including definitions, will control. In addition, the materials, methods, and examples are illustrative only and not intended to be limiting.

E-1,1,1,4,4,5,5,5-octafluoro-2-pentene, also known as E-HFO-1438mzz, may be made by methods known in the art, such as described in PCT Patent Publication No. WO2009/079525 by reacting CF₃CF₂CCl₂CF₂CF₃(CFC-41-10mca) with hydrogen in the presence of a dehalogenation catalyst to produce CF₃CF₂CCl═CFCF₃(CFC-1419myx); reacting CF₃CF₂CCl═CFCF₃(CFC-1419myx) with hydrogen in the presence of a dehalogenation catalyst to produce CF₃CF₂C≡CCF₃ (octafluoro-2-pentyne); and reacting CF₃CF₂C≡CCF₃, in a pressure vessel, with an hydrogenation catalyst to produce CF₃CF₂CH═CHCF₃ (1,1,1,4,4,5,5,5-octafluoro-2-pentene).

HFC-245eb, or 1,1,1,2,3-pentafluoropropane (CF₃CHFCH₂F), can be prepared by the hydrogenation of 1,1,1,2,3-pentafluoro-2,3,3-trichloropropane (CF₃CClFCCl₂F or CFC-215bb) over a palladium on carbon catalyst as disclosed in U.S. Patent Publication No. 2009-0264690 A1, incorporated herein in its entirety, or by hydrogenation of 1,2,3,3,3-pentafluoropropene (CF₃CF═CFH or HFO-1225ye) as disclosed in U.S. Pat. No. 5,396,000, incorporated herein by reference.

### Chiller Methods

A method is provided for producing cooling in a chiller having an evaporator wherein a refrigerant composition is evaporated to cool a heat transfer medium and the cooled heat transfer medium is transported out of the evaporator to a body to be cooled. The method comprises evaporating a refrigerant composition comprising E-HFO-1438mzz and optionally HFC-245eb in the evaporator. In one embodiment the method comprises (a) evaporating a liquid refrigerant composition comprising E-HFO-1438mzz and optionally HFC-245eb in an evaporator having a heat transfer medium passing therethrough thereby producing a vapor refrigerant composition; and (b) compressing the vapor refrigerant composition in a compressor. The compressor may be a positive displacement compressor or a centrifugal compressor. Positive displacement compressors include reciprocating, screw, or scroll compressors. Of note are methods for producing cooling that use centrifugal compressors. The method for producing cooling typically provides cooling to an external location wherein the heat transfer medium passes out of the evaporator to a body to be cooled.

Of particular utility in the method for producing cooling are those embodiments wherein the refrigerant composition consists essentially of E-HFO-1438mzz and optionally HFC-245eb. Also of particular utility are those embodiments wherein the refrigerant composition is azeotropic or azeotrope-like.

In one embodiment, the method for producing cooling may be useful wherein the chiller evaporator is suitable for use with HCFC-123 (2,2-dichloro-1,1,1-trifluoroethane).

In one embodiment, the method for producing cooling wherein the refrigerant composition evaporated consists essentially of HFC-245eb and E-HFO-1438mzz, wherein the weight percent E-HFO-1438mzz is 75 weight percent or less based on the total amount of HFC-245eb and E-HFO-1438mzz. Of note are methods wherein the refrigerant composition evaporated consists essentially of HFC-245eb and E-HFO-1438mzz, wherein the weight percent E-HFO-1438mzz is 76 weight percent or less based on the total amount of HFC-245eb and E-HFO-1438mzz. Of note are methods wherein the refrigerant composition evaporated consists essentially of HFC-245eb and E-HFO-1438mzz, wherein the weight percent E-HFO-1438mzz is 77 weight percent or less based on the total amount of HFC-245eb and E-HFO-1438mzz. Of note are methods wherein the refrigerant composition evaporated consists essentially of HFC-245eb and E-HFO-1438mzz, wherein the weight percent E-HFO-1438mzz is 78 weight percent or less based on the total amount of HFC-245eb and E-HFO-1438mzz. Of note are methods wherein the refrigerant composition evaporated consists essentially of HFC-245eb and E-HFO-1438mzz, wherein the weight percent E-HFO-1438mzz is 79 weight percent or less based on the total amount of HFC-245eb and E-HFO-1438mzz. Of note are methods wherein the refrigerant composition evaporated consists essentially of HFC-245eb and of HFC-245eb and E-HFO-1438mzz, wherein the weight percent E-HFO-1438mzz is 80 weight percent or less based on the total amount of HFC-245eb and E-HFO-1438mzz.

Of note are methods where the cooling performance, in terms of COP and volumetric cooling capacity, is within acceptable limits relative to the maximum performance achievable. For acceptable cooling performance, the refrigerant composition consists essentially of HFC-245eb and E-HFO-1438mzz and the amount of E-HFO-1438mzz is less than 50 weight percent. Also acceptable cooling performance, the refrigerant composition consists essentially of HFC-245eb and E-HFO-1438mzz and the amount of E-HFO-1438mzz is less than 55 weight percent. Also acceptable cooling performance, the refrigerant composition consists essentially of HFC-245eb and E-HFO-1438mzz and the amount of E-HFO-1438mzz is less than 60 weight percent. Also acceptable cooling performance, the refrigerant composition consists essentially of HFC-245eb and E-HFO-1438mzz and the amount of E-HFO-1438mzz is less than 65 weight percent. Also acceptable cooling performance, the refrigerant composition consists essentially of HFC-245eb and E-HFO-1438mzz and the amount of E-HFO-1438mzz is from 20 weight percent to 65 weight percent.

In another embodiment of the method for producing cooling the refrigerant composition evaporated is at least to 35 weight percent E-HFO-1438mzz based on the total amount of HFC-245eb and E-HFO-1438mzz.

In another embodiment of the method for producing cooling the refrigerant composition evaporated is at least 40 weight percent E-HFO-1438mzz based on the total amount of HFC-245eb and E-HFO-1438mzz.

In one embodiment of the method for producing cooling, the refrigerant composition evaporated consists essentially of E-HFO-1438mzz.

In another embodiment of the method for producing cooling the refrigerant composition evaporated consists essentially of E-HFO-1438mzz and HFC-245eb wherein the E-HFO-1438mzz in the refrigerant is at least 1 weight percent. In another embodiment of the method for producing cooling the refrigerant composition evaporated consists essentially of E-HFO-1438mzz and HFC-245eb wherein the E-HFO-1438mzz in the refrigerant is from about 1 weight percent to 65 weight percent.

In another embodiment of the method for producing cooling the refrigerant composition evaporated consists essentially of from 65 weight percent to 45 weight percent HFC-245eb and from about 35 weight percent to 55 weight percent E-HFO-1438mzz. Of note are methods wherein the refrigerant composition evaporated consists essentially of from 64 weight percent to 45 weight percent HFC-245eb and from 36 weight percent to 55 weight percent E-HFO-1438mzz. Also of note are methods wherein the refrigerant composition evaporated consists essentially of from 63 weight percent to 45 weight percent HFC-245eb and from 37 weight percent to 55 weight percent E-HFO-1438mzz. Also of note are methods wherein the refrigerant composition evaporated consists essentially of from 62 weight percent to 45 weight percent HFC-245eb and from 37 weight percent to 55 weight percent E-HFO-1438mzz. Also of note are methods wherein the refrigerant composition evaporated consists essentially of from 61 weight percent to 45 weight percent HFC-245eb and from about 39 weight percent to 55 weight percent E-HFO-1438mzz.

In another embodiment of the method for producing cooling the refrigerant composition evaporated consists essentially of from 60 weight percent to 45 weight percent HFC-245eb and from 40 weight percent to 55 weight percent E-HFO-1438mzz.

In one embodiment, a body to be cooled may be any space, object or fluid that may be cooled. In one embodiment, a body to be cooled may be a room, building, passenger compartment of an automobile, refrigerator, freezer, or supermarket or convenience store display case. Alternatively, in another embodiment, a body to be cooled may be a heat transfer medium or heat transfer fluid.

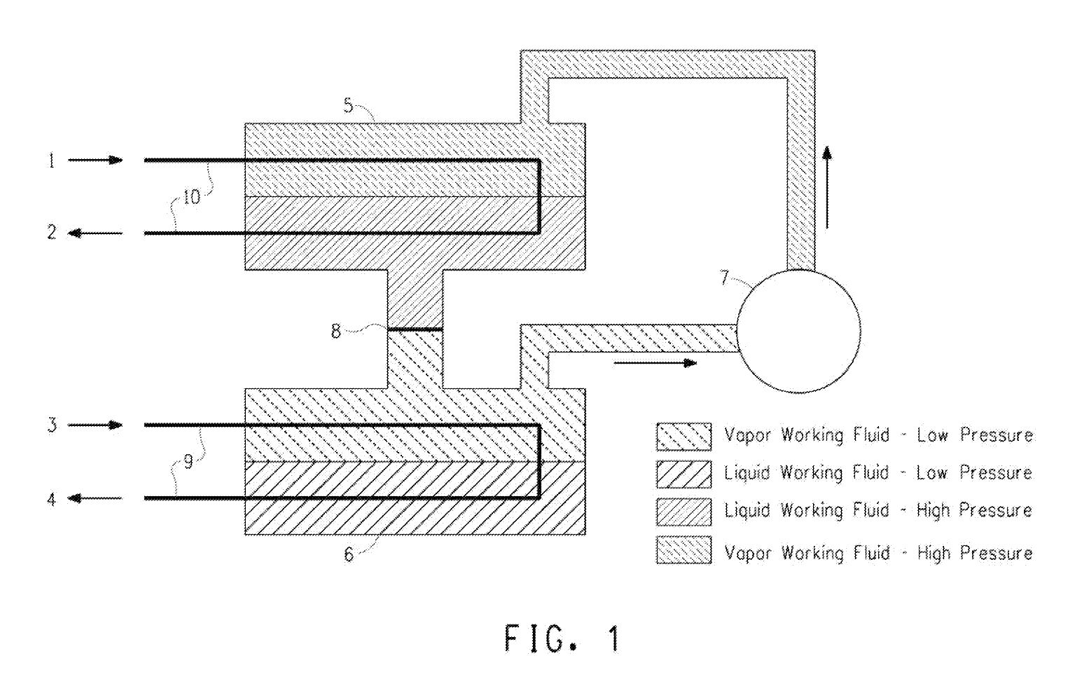

In one embodiment, the method for producing cooling comprises producing cooling in a flooded evaporator chiller as described above with respect to FIG. 1. In this method, the refrigerant component of the compositions as disclosed herein comprising E-HFO-1438mzz and optionally HFC-245eb is evaporated to form refrigerant vapor in the vicinity of a first heat transfer medium. The heat transfer medium is a warm liquid, such as water, which is transported into the evaporator via a pipe from a cooling system. The warm liquid is cooled and is passed to a body to be cooled, such as a building. The refrigerant composition vapor is then condensed in the vicinity of a second heat transfer medium, which is a chilled liquid which is brought in from, for instance, a cooling tower. The second heat transfer medium cools the refrigerant composition vapor such that it is condensed to form a liquid refrigerant. In this method, a flooded evaporator chiller may also be used to cool hotels, office buildings, hospitals and universities.

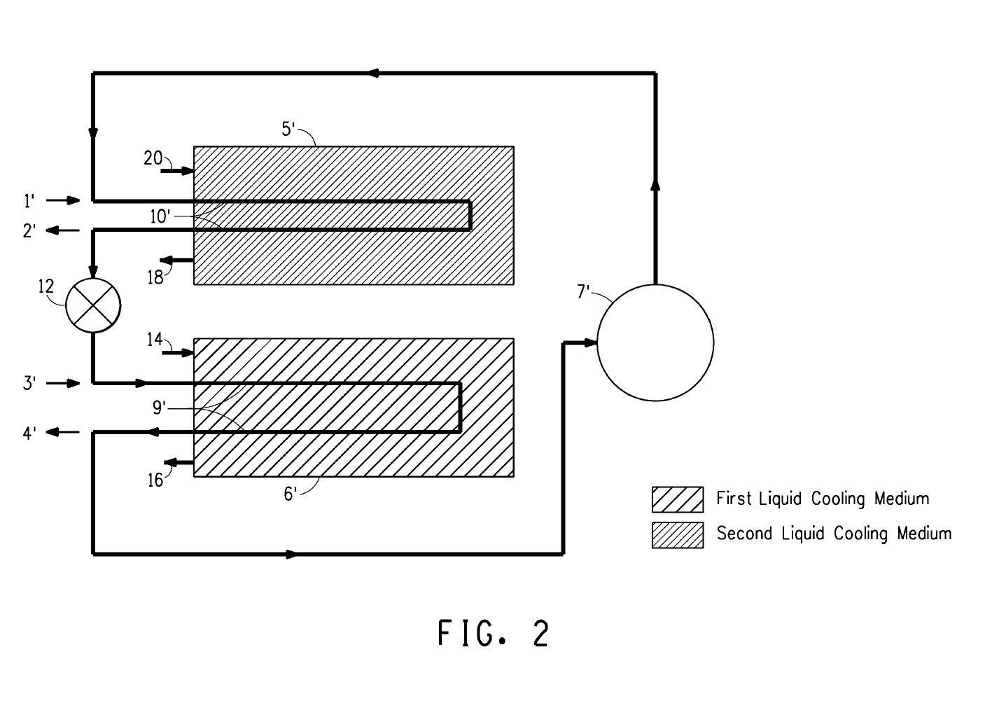

In another embodiment, the method for producing cooling comprises producing cooling in a direct expansion chiller as described above with respect to FIG. 2. In this method, the refrigerant component of the compositions as disclosed herein comprising E-HFO-1438mzz and optionally HFC-245eb is passed through an evaporator and evaporates to produce a refrigerant vapor. A first liquid heat transfer medium is cooled by the evaporating refrigerant composition. The first liquid heat transfer medium is passed out of the evaporator to a body to be cooled. In this method, the direct expansion chiller may also be used to cool hotels, office buildings, hospitals, universities, as well as naval submarines or naval surface vessels.

In either method for producing cooling in either a flooded evaporator chiller or in direct expansion chiller, the chiller includes a centrifugal compressor.

Refrigerants and heat transfer fluids that are in need of replacement, based upon their GWP values published by the Intergovernmental Panel on Climate Change (IPCC), include but are not limited to HCFC-123. Therefore, in accordance with the present invention, there is provided a method for replacing HCFC-123 in a chiller. The method for replacing a refrigerant composition in a chiller designed for using HCFC-123 as refrigerant composition, comprises charging said chiller with a composition comprising a refrigerant component consisting essentially of E-HFO-1438mzz and optionally HFC-245eb.

In this method of replacing HCFC-123, the compositions disclosed herein comprising a refrigerant component consisting essentially of E-HFO-1438mzz and optionally HFC-245eb are useful in centrifugal chillers that may have been originally designed and manufactured to operate with HCFC-123.

In replacing HCFC-123 with the compositions as disclosed herein comprising a refrigerant component consisting essentially of E-HFO-1438mzz and optionally HFC-245eb in existing equipment, additional advantages may be realized by making adjustments to equipment or operating conditions or both. For example, impeller diameter and impeller tip speed may be adjusted in a centrifugal chiller where a composition is being used as a replacement working fluid.

Alternatively, in the methods of replacing HCFC-123, the composition as disclosed herein comprising a refrigerant component consisting essentially of E-HFO-1438mzz and optionally HFC-245eb may be useful in new equipment, such as a new chiller comprising a flooded evaporator or a new compressor comprising a direct expansion evaporator.

### Chiller Apparatus

In accordance with this invention, a chiller apparatus is provided. The chiller apparatus is characterized by containing a refrigerant composition comprising E-HFO-1438mzz and optionally HFC-245eb. A chiller apparatus typically includes an evaporator, compressor, condenser and a pressure reduction device, such as a valve. A chiller apparatus can be of various types including dynamic (e.g., centrifugal) apparatus and positive displacement (e.g., screw) apparatus depending upon the type of compressor contained in the system.

Of particular utility in the chiller apparatus are those embodiments wherein the refrigerant composition consists essentially of E-HFO-1438mzz and optionally HFC-245eb. Also of particular utility are those embodiments wherein the refrigerant is azeotropic or azeotrope-like.

In one embodiment, the chiller apparatus may employ an evaporator suitable for use with HCFC-123 (2,2-dichloro-1,1,1-trifluoroethane).

In one embodiment of the chiller apparatus the refrigerant composition consists essentially of HFC-245eb and E-HFO-1438mzz, wherein the weight percent E-HFO-1438mzz is 75 weight percent or less based on the total amount of HFC-245eb and E-HFO-1438mzz. Of note are chiller apparatus wherein the refrigerant composition consists essentially of HFC-245eb and E-HFO-1438mzz, wherein the weight percent E-HFO-1438mzz is 76 weight percent or less based on the total amount of HFC-245eb and E-HFO-1438mzz. Of note are chiller apparatus wherein the refrigerant composition consists essentially of HFC-245eb and E-HFO-1438mzz, wherein the weight percent E-HFO-1438mzz is 77 weight percent or less based on the total amount of HFC-245eb and E-HFO-1438mzz. Of note are chiller apparatus wherein the refrigerant composition consists essentially of HFC-245eb and E-HFO-1438mzz, wherein the weight percent E-HFO-1438mzz is 78 weight percent or less based on the total amount of HFC-245eb and E-HFO-1438mzz. Of note are chiller apparatus wherein the refrigerant composition evaporated consists essentially of HFC-245eb and E-HFO-1438mzz, wherein the weight percent E-HFO-1438mzz is 79 weight percent or less based on the total amount of HFC-245eb and E-HFO-1438mzz. Of note are chiller apparatus wherein the refrigerant composition evaporated consists essentially of HFC-245eb and of HFC-245eb and E-HFO-1438mzz, wherein the weight percent E-HFO-1438mzz is 80 weight percent or less based on the total amount of HFC-245eb and E-HFO-1438mzz.

Also of note are chiller apparatus where the cooling performance, in terms of COP and volumetric cooling capacity, is within acceptable limits relative to the maximum performance achievable. For acceptable cooling performance, the refrigerant composition consists essentially of HFC-245eb and E-HFO-1438mzz and the amount of E-HFO-1438mzz is less than 50 weight percent. Also for acceptable cooling performance, the refrigerant composition consists essentially of HFC-245eb and E-HFO-1438mzz and the amount of E-HFO-1438mzz is less than 55 weight percent. Also for acceptable cooling performance, the refrigerant composition consists essentially of HFC-245eb and E-HFO-1438mzz and the amount of E-HFO-1438mzz is less than 60 weight percent. Also for acceptable cooling performance, the refrigerant composition consists essentially of HFC-245eb and E-HFO-1438mzz and the amount of E-HFO-1438mzz is less than 65 weight percent.

In another embodiment of the chiller apparatus the refrigerant composition is at least 35 weight percent E-HFO-1438mzz based on the total amount of HFC-245eb and E-HFO-1438mzz.

In another embodiment of the chiller apparatus the refrigerant composition is at least 40 weight percent E-HFO-1438mzz based on the total amount of HFC-245eb and E-HFO-1438mzz.

In one embodiment of the chiller apparatus, the refrigerant composition consists essentially of E-HFO-1438mzz.

In another embodiment of the chiller apparatus, the refrigerant composition consists essentially of E-HFO-1438mzz and HFC-245eb wherein the E-HFO-1438mzz in the refrigerant is at least 1 weight percent.

In another embodiment of the chiller apparatus, the refrigerant composition consists essentially of HFC-245eb and E-HFO-1438mzz and the amount of E-HFO-1438mzz is from 20 weight percent to 65 weight percent.

In another embodiment of the chiller apparatus the refrigerant composition consists essentially of from 65 weight percent to 45 weight percent HFC-245eb and from 35 weight percent to 55 weight percent E-HFO-1438mzz. Of note are chiller apparatus wherein the refrigerant composition consists essentially of from 64 weight percent to 45 weight percent HFC-245eb and from 36 weight percent to 55 weight percent E-HFO-1438mzz. Also of note are chiller apparatus wherein the refrigerant composition consists essentially of from 63 weight percent to 45 weight percent HFC-245eb and from 37 weight percent to 55 weight percent E-HFO-1438mzz. Also of note are chiller apparatus wherein the refrigerant composition consists essentially of from 62 weight percent to 45 weight percent HFC-245eb and from 37 weight percent to 55 weight percent E-HFO-1438mzz. Also of note are chiller apparatus wherein the refrigerant composition consists essentially of from 61 weight percent to 45 weight percent HFC-245eb and from 39 weight percent to 55 weight percent E-HFO-1438mzz.

In another embodiment of the chiller apparatus the refrigerant composition consists essentially of from 60 weight percent to 45 weight percent HFC-245eb and from 40 weight percent to 55 weight percent E-HFO-1438mzz.

A chiller is a type of air conditioning/refrigeration apparatus. The present disclosure is directed to a vapor compression chiller. Such vapor compression chillers may be either flooded evaporator chillers, one embodiment of which is shown in FIG. 1, or direct expansion chillers, one embodiment of which is shown in FIG. 2. Both a flooded evaporator chiller and a direct expansion chiller may be air-cooled or water-cooled. In the embodiment where chillers are water cooled, such chillers are generally associated with cooling towers for heat rejection from the system. In the embodiment where chillers are air-cooled, the chillers are equipped with refrigerant-to-air finned-tube condenser coils and fans to reject heat from the system. Air-cooled chiller systems are generally less costly than equivalent-capacity water-cooled chiller systems including cooling tower and water pump. However, water-cooled systems can be more efficient under many operating conditions due to lower condensing temperatures.

Chillers, including both flooded evaporator and direct expansion chillers, may be coupled with an air handling and distribution system to provide comfort air conditioning (cooling and dehumidifying the air) to large commercial buildings, including hotels, office buildings, hospitals, universities and the like. In another embodiment, chillers, most likely air-cooled direct expansion chillers, have found additional utility in naval submarines and surface vessels.

To illustrate how chillers operate, reference is made to the Figures.

A water-cooled, flooded evaporator chiller 100 is shown illustrated in FIG. 1. In this chiller a first heat transfer medium, which is a warm liquid, which comprises water, and, in some embodiments, additives, such as a glycol (e.g., ethylene glycol or propylene glycol), enters the chiller from a cooling system, such as a building cooling system, shown entering at arrow 3, through a coil or tube bundle 9, in an evaporator 6, which has an inlet and an outlet. The warm first heat transfer medium is delivered to the evaporator, where it is cooled by liquid refrigerant composition, which is shown in the lower portion of the evaporator. The liquid refrigerant composition evaporates at a temperature lower than the temperature of the warm first heat transfer medium which flows through coil 9. The cooled first heat transfer medium re-circulates back to the building cooling system, as shown by arrow 4, via a return portion of coil 9. The liquid refrigerant composition, shown in the lower portion of evaporator 6 in FIG. 1, vaporizes and is drawn into a compressor 7, which increases the pressure and temperature of the refrigerant composition vapor. The compressor compresses this vapor so that it may be condensed in a condenser 5 at a higher pressure and temperature than the pressure and temperature of the refrigerant composition vapor when it comes out of the evaporator. A second heat transfer medium, which is a liquid in the case of a water-cooled chiller, enters the condenser via a coil or tube bundle 10 in condenser 5 from a cooling tower at arrow 1 in FIG. 1. The second heat transfer medium is warmed in the process and returned via a return loop of coil 10 and arrow 2 to a cooling tower or to the environment. This second heat transfer medium cools the vapor in the condenser and causes the vapor to condense to liquid refrigerant composition, so that there is liquid refrigerant composition in the lower portion of the condenser as shown in FIG. 1. The condensed liquid refrigerant composition in the condenser flows back to the evaporator through an expansion device 8, which may be an orifice, capillary tube or expansion valve. Expansion device 8 reduces the pressure of the liquid refrigerant composition, and converts the liquid refrigerant composition partially to vapor, that is to say that the liquid refrigerant composition flashes as pressure drops between the condenser and the evaporator. Flashing cools the refrigerant composition, i.e., both the liquid refrigerant composition and the refrigerant composition vapor to the saturation temperature at evaporator pressure, so that both liquid refrigerant composition and refrigerant vapor composition are present in the evaporator.

It should be noted that for a single component refrigerant composition, the composition of the vapor refrigerant composition in the evaporator is the same as the composition of the liquid refrigerant composition in the evaporator. In this case, evaporation will occur at a constant temperature. However, if a refrigerant blend (or mixture) is used, as in the present invention, the liquid refrigerant composition and the refrigerant composition vapor in the evaporator (or in the condenser) may have different compositions. This may lead to inefficient systems and difficulties in servicing the equipment, thus a single component refrigerant composition is more desirable. An azeotrope or azeotrope-like composition will function essentially as a single component refrigerant composition in a chiller, such that the liquid refrigerant composition and the vapor refrigerant composition are essentially the same reducing any inefficiencies that might arise from the use of a non-azeotropic or non-azeotrope-like composition.

Chillers with cooling capacities above 700 kW generally employ flooded evaporators, where the refrigerant in the evaporator and the condenser surrounds a coil or tube bundle or other conduit for the heat transfer medium (i.e., the refrigerant composition is on the shell side). Flooded evaporators require larger charges of refrigerant, but permit closer approach temperatures and higher efficiencies. Chillers with capacities below 700 kW commonly employ evaporators with refrigerant composition flowing inside the tubes and heat transfer medium in the evaporator and the condenser surrounding the tubes, i.e., the heat transfer medium is on the shell side. Such chillers are called direct-expansion (DX) chillers. One embodiment of a water-cooled direct expansion chiller is illustrated in FIG. 2. In the chiller as illustrated in FIG. 2, first liquid cooling medium, which is a warm liquid, such as warm water, enters evaporator 6′ at inlet 14. Mostly liquid refrigerant composition (with a small amount of refrigerant composition vapor) enters coil or tube bundle 9′ in evaporator 6′ at arrow 3′ and evaporates. As a result, first liquid cooling medium is cooled in evaporator 6′, and a cooled first liquid cooling medium exits evaporator 6′ at outlet 16, and is sent to a body to be cooled, such as a building. In this embodiment of FIG. 2, it is this cooled first liquid cooling medium that cools the building or other body to be cooled. The refrigerant composition vapor exits evaporator 6′ at arrow 4′ and is sent to compressor 7′, where it is compressed and exits as high temperature, high pressure refrigerant composition vapor. This refrigerant composition vapor enters condenser 5′ through condenser coil or tube bundle 10′ at 1′. The refrigerant composition vapor is cooled by a second liquid cooling medium, such as water, in condenser 5′ and becomes a liquid. The second liquid cooling medium enters condenser 5′ through condenser heat transfer medium inlet 20. The second liquid cooling medium extracts heat from the condensing refrigerant composition vapor, which becomes liquid refrigerant composition, and this warms the second liquid cooling medium in condenser 5′. The second liquid cooling medium exits through condenser heat transfer medium outlet 18. The condensed refrigerant composition liquid exits condenser 5′ through lower coil 10′ and flows through expansion device 12, which may be an orifice, capillary tube or expansion valve. Expansion device 12 reduces the pressure of the liquid refrigerant composition. A small amount of vapor, produced as a result of the expansion, enters evaporator 6′ with liquid refrigerant composition through coil 9′ and the cycle repeats.

Vapor-compression chillers may be identified by the type of compressor they employ. The present invention includes chillers utilizing centrifugal compressors as well as positive displacement compressors. In one embodiment, the compositions as disclosed herein are useful in chillers which utilizes a centrifugal compressor, herein referred to as a centrifugal chiller.

A centrifugal compressor uses rotating elements to accelerate the refrigerant radially, and typically includes an impeller and diffuser housed in a casing. Centrifugal compressors usually take fluid in at an impeller eye, or central inlet of a circulating impeller, and accelerate it radially outward. Some static pressure rise occurs in the impeller, but most of the pressure rise occurs in the diffuser section of the casing, where velocity is converted to static pressure. Each impeller-diffuser set is a stage of the compressor. Centrifugal compressors are built with from 1 to 12 or more stages, depending on the final pressure desired and the volume of refrigerant to be handled.

The pressure ratio, or compression ratio, of a compressor is the ratio of absolute discharge pressure to the absolute inlet pressure. Pressure delivered by a centrifugal compressor is practically constant over a relatively wide range of capacities. The pressure a centrifugal compressor can develop depends on the tip speed of the impeller. Tip speed is the speed of the impeller measured at its outermost tip and is related to the diameter of the impeller and its revolutions per minute. The capacity of the centrifugal compressor is determined by the size of the passages through the impeller. This makes the size of the compressor more dependent on the pressure required than the capacity.

In another embodiment, the compositions as disclosed herein are useful in positive displacement chillers, which utilize positive displacement compressors, either reciprocating, screw, or scroll compressors. A chiller which utilizes a screw compressor will be hereinafter referred to as a screw chiller.

Positive displacement compressors draw vapor into a chamber, and the chamber decreases in volume to compress the vapor. After being compressed, the vapor is forced from the chamber by further decreasing the volume of the chamber to zero or nearly zero.

Reciprocating compressors use pistons driven by a crankshaft. They can be either stationary or portable, can be single or multi-staged, and can be driven by electric motors or internal combustion engines. Small reciprocating compressors from 5 to 30 hp are seen in automotive applications and are typically for intermittent duty. Larger reciprocating compressors up to 100 hp are found in large industrial applications. Discharge pressures can range from low pressure to very high pressure (>5000 psi or 35 MPa).

Screw compressors use two meshed rotating positive-displacement helical screws to force the gas into a smaller space. Screw compressors are usually for continuous operation in commercial and industrial application and may be either stationary or portable. Their application can be from 5 hp (3.7 kW) to over 500 hp (375 kW) and from low pressure to very high pressure (>1200 psi or 8.3 MPa).

Scroll compressors are similar to screw compressors and include two interleaved spiral-shaped scrolls to compress the gas. The output is more pulsed than that of a rotary screw compressor.

For chillers which use scroll compressors or reciprocating compressors, capacities below 150 kW, brazed-plate heat exchangers are commonly used for evaporators instead of the shell-and-tube heat exchangers employed in larger chillers. Brazed-plate heat exchangers reduce system volume and refrigerant charge.

The compositions comprising E-HFO-1438mzz and optionally HFC-245eb may be used in a chiller apparatus in combination with molecular sieves to aid in removal of moisture. Desiccants may be composed of activated alumina, silica gel, or zeolite-based molecular sieves. In some embodiments, the molecular sieves are most useful with a pore size of approximately 3 Angstroms, 4 Angstroms, or 5 Angstroms. Representative molecular sieves include MOLSIV XH-7, XH-6, XH-9 and XH-11 (UOP LLC, Des Plaines, Ill.).

### Compositions

The compositions comprising E-HFO-1438mzz and HFC-245eb that are particularly useful in chillers are azeotropic or azeotrope-like.

It has been disclosed that E-HFO-1438mzz and HFC-245eb form azeotropic and azeotrope-like compositions in U.S. Provisional Patent Application Ser. No. 61/439,389, filed Feb. 4, 2011 (now published as PCT International Patent Application Publication No. WO2012/106656, published Aug. 9, 2012).

Azeotropic compositions will have zero glide in the heat exchangers, e.g., evaporator and condenser, of a chiller apparatus. Azeotropic and azeotrope-like compositions are particularly useful in flooded evaporator chillers because the performance of flooded evaporated chillers deteriorates when refrigerant compositions that fractionate are used. Refrigerant mixtures that are not azeotropic or azeotrope-like fractionate to some degree while in use in a chiller.

Of note are compositions E-HFO-1438mzz and HFC-245eb that are non-flammable. It is expected that certain compositions comprising E-HFO-1438mzz and HFC-245eb are non-flammable by standard test ASTM 681. Of particular note are compositions containing E-HFO-1438mzz and HFC-245eb with at least 35 weight percent E-HFO-1438mzz. Also of particular note are compositions containing E-HFO-1438mzz and HFC-245eb with at least 36 weight percent E-HFO-1438mzz. Also of particular note are compositions containing E-HFO-1438mzz and HFC-245eb with at least 37 weight percent E-HFO-1438mzz. Also of particular note are compositions containing E-HFO-1438mzz and HFC-245eb with at least 38 weight percent E-HFO-1438mzz. Also of particular note are compositions containing E-HFO-1438mzz and HFC-245eb at least 39 weight percent E-HFO-1438mzz. Of particular note are compositions containing E-HFO-1438mzz and HFC-245eb at least 40 weight percent E-HFO-1438mzz.

Any of the compositions described herein can be used in a chiller. In one embodiment of the invention the compositions useful in a chiller comprise: (1) a refrigerant component consisting essentially of HFC-245eb and E-HFO-1438mzz; and (2) a lubricant suitable for use in a chiller; wherein the E-HFO-1438mzz in the refrigerant component is at least 1 weight percent.

Of note are compositions wherein the E-HFO-1438mzz in the refrigerant is 75 weight percent or less. Also of note are compositions wherein the refrigerant component consists essentially of from 65 weight percent to 45 weight percent HFC-245eb and from 35 weight percent to 55 weight percent E-HFO-1438mzz. Of particular note are compositions wherein the refrigerant component consists essentially of from 60 weight percent to 45 weight percent HFC-245eb and from 40 weight percent to 55 weight percent E-HFO-1438mzz.

Lubricants for use in a chiller may be polyalkylene glycols, polyol esters, polyvinylethers, mineral oils, alkylbenzenes, synthetic paraffins, synthetic naphthenes, poly(alpha)olefins or mixtures thereof.

Useful lubricants include those suitable for use with chiller apparatus. Among these lubricants are those conventionally used in vapor compression refrigeration apparatus utilizing chlorofluorocarbon refrigerants. In one embodiment, lubricants comprise those commonly known as “mineral oils” in the field of compression refrigeration lubrication. Mineral oils comprise paraffins (i.e., straight-chain and branched-carbon-chain, saturated hydrocarbons), naphthenes (i.e. cyclic paraffins) and aromatics (i.e. unsaturated, cyclic hydrocarbons containing one or more rings characterized by alternating double bonds). In one embodiment, lubricants comprise those commonly known as “synthetic oils” in the field of compression refrigeration lubrication. Synthetic oils comprise alkylaryls (i.e. linear and branched alkyl alkylbenzenes), synthetic paraffins and naphthenes, and poly(alphaolefins). Representative conventional lubricants are the commercially available BVM 100 N (paraffinic mineral oil sold by BVA Oils), naphthenic mineral oil commercially available from Crompton Co. under the trademarks Suniso® 3GS and Suniso® 5GS, naphthenic mineral oil commercially available from Pennzoil under the trademark Sontex® 372LT, naphthenic mineral oil commercially available from Calumet Lubricants under the trademark Calumet® RO-30, linear alkylbenzenes commercially available from Shrieve Chemicals under the trademarks Zerol® 75, Zerol® 150 and Zerol® 500, and HAB 22 (branched alkylbenzene sold by Nippon Oil).

Useful lubricants may also include those which have been designed for use with hydrofluorocarbon refrigerants and are miscible with refrigerants of the present invention under compression refrigeration and air-conditioning apparatus' operating conditions. Such lubricants include, but are not limited to, polyol esters (POEs) such as Castrol® 100 (Castrol, United Kingdom), polyalkylene glycols (PAGs) such as RL-488A from Dow (Dow Chemical, Midland, Mich.), polyvinyl ethers (PVEs), and polycarbonates (PCs).

Preferred lubricants are polyol esters.

Lubricants used with the refrigerants disclosed herein are selected by considering a given compressor's requirements and the environment to which the lubricant will be exposed.

In one embodiment, any one of the compositions as disclosed herein may further comprise an additive selected from the group consisting of compatibilizers, UV dyes, solubilizing agents, tracers, stabilizers, perfluoropolyethers (PFPE), and functionalized perfluoropolyethers.

In one embodiment, any one of the compositions may be used with 0.01 weight percent to 5 weight percent of a stabilizer, free radical scavenger or antioxidant. Such other additives include but are not limited to, nitromethane, hindered phenols, hydroxylamines, thiols, phosphites, or lactones. Single additives or combinations may be used.

Optionally, in another embodiment, certain refrigeration or air-conditioning system additives may be added, as desired, to the in order to enhance performance and system stability for any of the compositions as disclosed herein. These additives are known in the field of refrigeration and air-conditioning, and include, but are not limited to, anti wear agents, extreme pressure lubricants, corrosion and oxidation inhibitors, metal surface deactivators, free radical scavengers, and foam control agents. In general, these additives may be present in the inventive compositions in small amounts relative to the overall composition. Typically concentrations of from less than 0.1 weight percent to as much as 3 weight percent of each additive are used. These additives are selected on the basis of the individual system requirements. These additives include members of the triaryl phosphate family of EP (extreme pressure) lubricity additives, such as butylated triphenyl phosphates (BTPP), or other alkylated triaryl phosphate esters, e.g. Syn-O-Ad 8478 from Akzo Chemicals, tricresyl phosphates and related compounds. Additionally, the metal dialkyl dithiophosphates (e.g., zinc dialkyl dithiophosphate (or ZDDP), Lubrizol 1375 and other members of this family of chemicals may be used in compositions of the present invention. Other antiwear additives include natural product oils and asymmetrical polyhydroxyl lubrication additives, such as Synergol TMS (International Lubricants). Similarly, stabilizers such as antioxidants, free radical scavengers, and water scavengers may be employed. Compounds in this category can include, but are not limited to, butylated hydroxy toluene (BHT), epoxides, and mixtures thereof. Corrosion inhibitors include dodecyl succinic acid (DDSA), amine phosphate (AP), oleoyl sarcosine, imidazone derivatives and substituted sulfphonates.

### EXAMPLES

The concepts described herein will be further described in the following examples, which do not limit the scope of the invention described in the claims.

### Example 1

### Cooling Performance Using E-HFO-1438mzz

This example demonstrates the use of “neat” E-HFO-1438mzz as a replacement for HCFC-123 in chillers. In Table 1, Pevap is pressure of the evaporator; Pcond is pressure of the condenser; PR is pressure ratio (Pcond/Pevap); COP is coefficient of performance (a measure of energy efficiency); and volumetric CAP is volumetric capacity. The performance for “neat” E-HFO-1438mzz and HCFC-123 is determined for the following conditions:

Evaporator Temperature=4.44° C.

Condenser Temperature=37.8° C.

TABLE 1

| | | | E-HFO- | | Z-HFO- |
|---|---|---|---|---|---|
| | | | 1438mzz | | 1438mzz |
| | HCFC- | E-HFO- | vs HCFC- | Z-HFO- | vs HCFC- |
| | 123 | 1438mzz | 123 % | 1438mzz | 123 % |
| GWP | 77 | | | | |
| ODP | 0.02 | 0 | | 0 | |
| SuperHeat, K | 0.00 | 4.00 | | 0.45 | |
| SubCool, K | 0.00 | 0.00 | | 0.00 | |
| Pevap, kPa | 39.88 | 35.60 | −10.73 | 12.87 | −67.74 |
| Pcond, kPa | 143.76 | 139.06 | −3.27 | 55.19 | −61.61 |
| PR | 3.60 | 3.91 | 8.36 | 4.29 | 19.00 |
| Compr Work- | 19.85 | 14.85 | −25.21 | 16.06 | −19.09 |
| isentr [kJ/kg] | | | | | |
| Volumetric | 393.63 | 344.09 | −12.59 | 138.17 | −64.90 |
| CAP [kJ/m³] | | | | | |
| COP | 7.378 | 6.971 | −5.51 | 7.148 | −3.11 |
| Tip Speed | 189.99 | 164.30 | −13.52 | 170.89 | −10.05 |
| [m/sec] | | | | | |

The evaporator and condenser pressures with E-HFO-1438mzz are relatively close (within about 11%) to those with HCFC-123. E-HFO-1438mzz has a volumetric cooling capacity within about 13% of that of HCFC-123 and requires about 13% lower impeller tip speed. E-HFO-1438mzz could enable chiller designs similar to those based on HCFC-123 thus minimizing design costs and development risks. E-HFO-1438mzz could also replace HCFC-123 in existing chillers (most likely with suitable adjustments of the equipment and operating conditions).

In contrast, the evaporator and condenser pressures with the Z-HFO-1438mzz isomer would both be below atmospheric pressure (101 kPa) and substantially lower (by over 60%) than with HCFC-123 thus increasing the risk of air and moisture infiltration. Air and moisture infiltration would have detrimental effects on condenser performance and long-term material stability. The volumetric cooling capacity of Z-HFO-1438mzz would be about 65% lower than HCFC-123. As a consequence the physical size and cost of chillers with a given cooling capacity would be substantially larger with Z-HFO-1438mzz than HCFC-123. Replacing HCFC-123 in existing chillers with Z-HFO-1438mzz would be impractical in most cases.

Therefore, E-HFO-1438mzz enables chiller performance similar to that of HCFC-123 while providing a low GWP and zero ODP.

### Example 2

### Cooling Performance of E-HFO-1438mzz/HFC-245eb Blends in Centrifugal Chillers

This example demonstrates the use of E-HFO-1438mzz/HFC-245eb blends, A, B, C and D, in centrifugal chillers as a replacements for CFC-11 and HCFC-123. In Table 2, Pₑᵥₐₚ is pressure of the evaporator; P_{cond} is pressure of the condenser; PR is pressure ratio (P_{cond}/Pₑᵥₐₚ); COP is coefficient of performance (a measure of energy efficiency); and CAP is volumetric capacity. Table 2 shows the performance of E-HFO-1438mzz/HFC-245eb blends of selected compositions, A, B, C and D, in centrifugal chillers to the performance of CFC-11 and HCFC-123. The performance for E-HFO-1438mzz/HFC-245eb blends, A, B, C, and D, and CFC-11 and HCFC-123 is determined for the following conditions:

Evaporator Temperature=4.44° C.

Condenser Temperature=37.8° C.

Compressor efficiency=0.70

TABLE 2

| | Blend | Blend | Blend | Blend | CFC- | HCFC- |
|---|---|---|---|---|---|---|
| | A | B | C | D | 11 | 123 |
| E-HFO- | 20 | 35 | 50 | 65 | | |
| 1438mzz | | | | | | |
| (wt %) | | | | | | |
| HFC-245eb | 80 | 65 | 50 | 35 | | |
| (wt %) | | | | | | |
| Blend GWP(*) | 235 | 197 | 159 | 121 | | |
| Compressor | 0.7 | 0.7 | 0.7 | 0.7 | 0.7 | 0.7 |
| Efficiency | | | | | | |
| Pₑᵥₐₚ (MPa) | 0.05 | 0.05 | 0.05 | 0.05 | 0.05 | 0.04 |
| P_{cond} (MPa) | 0.18 | 0.19 | 0.18 | 0.17 | 0.16 | 0.14 |
| PR | 3.76 | 3.74 | 3.74 | 3.77 | 3.36 | 3.61 |
| COP_{cool} | 5.105 | 5.059 | 5.01 | 4.96 | 5.268 | 5.103 |
| COP_{cool} vs | −3.4 | −4.4 | −5.4 | −6.4 | | −3.4 |
| CFC-11 (%) | | | | | | |
| COP_{cool} vs | 0.0 | −0.9 | −1.8 | −2.8 | 3.2 | |
| HCFC-123 (%) | | | | | | |
| CAP_{cool} | 490.7 | 487.1 | 471.8 | 444.9 | 464.0 | 386.5 |
| (kJ/m³) | | | | | | |
| CAP_{cool} vs | 5.8 | 5.0 | 1.7 | −4.1 | | −16.7 |
| CFC-11 (%) | | | | | | |
| CAP_{cool} vs | 27.0 | 26.0 | 22.1 | 15.1 | 20.0 | |
| HCFC-123 (%) | | | | | | |
| Compression | 30.6 | 28.5 | 26.5 | 24.8 | 30.2 | 28.2 |
| Work-Actual | | | | | | |
| (kJ/kg) | | | | | | |
| Tip Speed | 197.4 | 190.4 | 183.7 | 177.5 | 196.1 | 189.4 |
| (m/s) | | | | | | |
| Tip Speed vs | 0.7 | −2.9 | −6.3 | −9.5 | | −3.4 |
| CFC-11 (%) | | | | | | |
| Tip Speed vs | 4.2 | 0.5 | −3.0 | −6.3 | 3.5 | |
| HCFC-123 (%) | | | | | | |
| Evaporator | 0.10 | 0.00 | 0.26 | 0.78 | 0.00 | 0.00 |
| Glide | | | | | | |
| Condenser | 0.06 | 0.01 | 0.31 | 0.87 | 0.00 | 0.00 |
| Glide | | | | | | |

(*)GWP_{HFO-1438mzz-E} = 32; GWP_{HFC-245eb} = 286

All E-HFO-1438mzz/HFC-245eb blends have zero ODP and substantially lower GWPs than CFC-11. Blends containing more than about 35 weight percent E-HFO-1438mzz are expected to be non-flammable.

The evaporator pressures, condenser pressures and pressure ratios with all E-HFO-1438mzz/HFC-245eb blends in Table 2 are similar to those with CFC-11 and HCFC-123. The cycle COP for cooling with all blends is comparable to that with HCFC-123. The cycle COP for cooling with all blends is about 3-6% lower than with CFC-11. The reduction in cycle COP resulting from replacing CFC-11 with an E-HFO-1438mzz/HFC-245eb blend would be comparable to the reduction that resulted from replacing CFC-11 with HCFC-123 (3.4%). The volumetric cooling capacity with the various E-HFO-1438mzz/HFC-245eb blends is substantially higher (15-27%) than with HCFC-123. The volumetric cooling capacity with the various E-HFO-1438mzz/HFC-245eb blends is comparable (−4.1% to +5.8%) to that with CFC-11. The required impeller tip speeds with the various blends are comparable to the values required with CFC-11 or HCFC-123. The impeller tip speed required with blend B, in particular, is virtually identical to that required with HCFC-123. The evaporator and condenser temperature glide with an E-HFO-1438mzz/HFC-245eb blend as the working fluid would be minimal. The evaporator and condenser temperature glide with Blend B, in particular, would be negligible.

Blend B offers the maximum COP and volumetric cooling capacity, lowest glide and a required impeller tip speed closest to the tip speed required with HCFC-123 among E-HFO-1438mzz/HFC-245eb blends expected to be non-flammable. An E-HFO-1438mzz/HFC-245eb blend containing more than 54 weight percent E-HFO-1438mzz would have a GWP lower than 150.

### SELECTED EMBODIMENTS

### Embodiment A1

A method for producing cooling in a chiller having an evaporator wherein a refrigerant composition is evaporated to cool a heat transfer medium and the cooled heat transfer medium is transported out of the evaporator to a body to be cooled, comprising evaporating a refrigerant composition comprising E-HFO-1438mzz and optionally HFC-245eb in the evaporator; wherein said chiller is a centrifugal chiller.

### Embodiment A2

The method of Embodiment A1 wherein the chiller evaporator is suitable for use with HCFC-123.

### Embodiment A3

The method of any of Embodiments A1-A2 wherein the refrigerant composition evaporated consists essentially of HFC-245eb and E-HFO-1438mzz and wherein the weight percent E-HFO-1438mzz based on the total amount of HFC-245eb and E-HFO-1438mzz is 75 weight percent or less.

### Embodiment A4

The method of any of Embodiments A1-A3 wherein the weight percent of E-HFO-1438mzz in the refrigerant composition evaporated is at least 40 weight percent based on the total amount of HFC-245eb and E-HFO-1438mzz.

### Embodiment A5

The method of any of Embodiments A1-A2 wherein the refrigerant composition evaporated consists essentially of E-HFO-1438mzz.

### Embodiment A6

The method of any of Embodiments A1-A4 wherein the refrigerant composition evaporated consists essentially of E-HFO-1438mzz and HFC-245eb and wherein the E-HFO-1438mzz in the refrigerant is at least 1 weight percent.

### Embodiment A7

The method of any of Embodiments A1-A4 wherein the refrigerant composition evaporated consists essentially of from 65 weight percent to 45 weight percent HFC-245eb and from 35 weight percent to 55 weight percent E-HFO-1438mzz.

### Embodiment A8

The method of any of Embodiments A1-A4 or A6 wherein the refrigerant composition evaporated consists essentially of from 60 weight percent to 45 weight percent HFC-245eb and from 40 weight percent to 55 weight percent E-HFO-1438mzz.

### Embodiment B1

A composition comprising: (1) a refrigerant component consisting essentially of HFC-245eb and E-HFO-1438mzz; and (2) a lubricant suitable for use in a chiller; wherein the E-HFO-1438mzz in the refrigerant component is at least 1 weight percent.

### Embodiment B2

The composition of Embodiment B1, wherein the E-HFO-1438mzz in the refrigerant is 75 weight percent or less.

### Embodiment B3

The composition of any of Embodiments B1-B2 wherein the refrigerant component consists essentially of from 65 weight percent to 45 weight percent HFC-245eb and from 35 weight percent to 55 weight percent E-HFO-1438mzz.

### Embodiment B4

The composition of any of Embodiments B1-B2 wherein the refrigerant component consists essentially of from 60 weight percent to 45 weight percent HFC-245eb and from 40 weight percent to 55 weight percent E-HFO-1438mzz.

### Embodiment B5

The composition of claim 9 further comprising an additive selected form the group consisting of compatibilizers, UV dyes, solubilizing agents, tracers, stabilizers, perfluoropolyethers, and functionalized perfluoropolyethers.

### Embodiment B6

The composition of claim 9 further comprising 0.01 to 5 weight percent of a stabilizer, free radical scavenger or antioxidant.

### Embodiment C1

A centrifugal chiller apparatus containing a refrigerant composition, characterized by:
said refrigerant composition comprising E-HFO-1438mzz and optionally HFC-245eb.

### Embodiment C2

The centrifugal chiller apparatus of Embodiment C1, wherein said refrigerant composition comprises from 60 weight percent to 45 weight percent HFC-245eb and from 40 weight percent to 55 weight percent E-HFO-1438mzz.

### Embodiment C3

The centrifugal chiller apparatus of Embodiment C1 or C2, wherein the refrigerant composition comprises: (1) a refrigerant component consisting essentially of HFC-245eb and E-HFO-1438mzz; and (2) a lubricant suitable for use in a chiller; wherein the E-HFO-1438mzz in the refrigerant component is at least 1 weight percent.

### Embodiment D1

A method for replacing HCFC-123 in a centrifugal chiller designed for using HCFC-123 as refrigerant composition, said method comprising charging said centrifugal chiller with a composition comprising a refrigerant component consisting essentially of E-HFO-1438mzz and optionally HFC-245eb.

### Embodiment D2

The method of Embodiment D1, wherein the refrigerant component consists essentially of from 60 weight percent to 45 weight percent HFC-245eb and from 40 weight percent to 55 weight percent E-HFO-1438mzz.

What is claimed is:

1. A method for producing cooling in a chiller having an evaporator wherein a refrigerant composition is evaporated to cool a heat transfer medium and the cooled heat transfer medium is transported out of the evaporator to a body to be cooled, comprising evaporating a refrigerant composition comprising E-HFO-1438mzz and optionally HFC-245eb in the evaporator; wherein said chiller is a centrifugal chiller.

2. The method of claim 1 wherein the chiller evaporator is suitable for use with HCFC-123.

3. The method of claim 1 and wherein the refrigerant composition evaporated consists essentially of HFC-245eb and E-HFO-1438mzz and wherein the weight percent E-HFO-1438mzz based on the total amount of HFC-245eb and E-HFO-1438mzz is 75 weight percent or less.

4. The method of claim 3 wherein the weight percent of E-HFO-1438mzz in the refrigerant composition evaporated is at least 40 weight percent based on the total amount of HFC-245eb and E-HFO-1438mzz.

5. The method of claim 1 wherein the refrigerant composition evaporated consists essentially of E-HFO-1438mzz.

6. The method of claim 1 wherein the refrigerant composition evaporated consists essentially of E-HFO-1438mzz and HFC-245eb and wherein the E-HFO-1438mzz in the refrigerant is at least 1 weight percent.

7. The method of claim 6 wherein the refrigerant composition evaporated consists essentially of from 65 weight percent to 45 weight percent HFC-245eb and from 35 weight percent to 55 weight percent E-HFO-1438mzz.

8. The method of claim 6 wherein the refrigerant composition evaporated consists essentially of from 60 weight percent to 45 weight percent HFC-245eb and from 40 weight percent to 55 weight percent E-HFO-1438mzz.

9. A composition comprising: (1) a refrigerant component consisting essentially of HFC-245eb and E-HFO-1438mzz; and (2) a lubricant suitable for use in a chiller; wherein the E-HFO-1438mzz in the refrigerant component is at least 1 weight percent.

10. The composition of claim 9, wherein the E-HFO-1438mzz in the refrigerant is 75 weight percent or less.

11. The composition of claim 9 wherein the refrigerant component consists essentially of from 65 weight percent to 45 weight percent HFC-245eb and from 35 weight percent to 55 weight percent E-HFO-1438mzz.

12. The composition of claim 9 wherein the refrigerant component consists essentially of from 60 weight percent to 45 weight percent HFC-245eb and from 40 weight percent to 55 weight percent E-HFO-1438mzz.

13. The composition of claim 9 further comprising an additive selected form the group consisting of compatibilizers, UV dyes, solubilizing agents, tracers, stabilizers, perfluoropolyethers, and functionalized perfluoropolyethers.

14. The composition of claim 9 further comprising 0.01 to 5 weight percent of a stabilizer, free radical scavenger or antioxidant.

15. A centrifugal chiller apparatus containing a refrigerant composition, characterized by:
said refrigerant composition comprising E-HFO-1438mzz and optionally HFC-245eb.

16. The centrifugal chiller apparatus of claim 14, wherein said refrigerant composition comprises from 60 weight percent to 45 weight percent HFC-245eb and from 40 weight percent to 55 weight percent E-HFO-1438mzz.

17. The centrifugal chiller apparatus of claim 14, wherein the refrigerant composition comprises: (1) a refrigerant component consisting essentially of HFC-245eb and E-HFO-1438mzz; and (2) a lubricant suitable for use in a chiller; wherein the E-HFO-1438mzz in the refrigerant component is at least 1 weight percent.

18. A method for replacing HCFC-123 in a centrifugal chiller designed for using HCFC-123 as refrigerant composition, said method comprising charging said centrifugal chiller with a composition comprising a refrigerant component consisting essentially of E-HFO-1438mzz and optionally HFC-245eb.

19. The method of claim 18 wherein the refrigerant component consists essentially of from 60 weight percent to 45 weight percent HFC-245eb and from 40 weight percent to 55 weight percent E-HFO-1438mzz.
